(19) United States
(12) Patent Application Publication
(10) Pub. No.: US 2022/0337710 A1
(43) Pub. Date: Oct. 20, 2022

(54) MEASUREMENT IMAGE MANAGEMENT SYSTEM, MEASUREMENT IMAGE MANAGEMENT SERVER, AND MEASUREMENT IMAGE MANAGEMENT METHOD

(71) Applicant: SHIMADZU CORPORATION, Kyoto-shi (JP)

(72) Inventors: Shuhei YAMAMOTO, Kyoto-shi (JP); Ryuji SAWADA, Kyoto-shi (JP); Takeshi ONO, Kyoto-shi (JP)

(73) Assignee: SHIMADZU CORPORATION, Kyoto-shi (JP)

(21) Appl. No.: 17/667,742

(22) Filed: Feb. 9, 2022

(30) Foreign Application Priority Data
Apr. 20, 2021 (JP) 2021-071097

(51) Int. Cl. H04N 1/00; H04N 1/32

(52) U.S. Cl. CPC H04N 1/00209; H04N 1/32368

(57) ABSTRACT

A measurement image management system acquires identification information to identify a selected image from a plurality of measurement images, presents the identification information to a plurality of user terminals such that the identification information is selectable, and transmits, to a user terminal that has received an input operation for image transmission among the plurality of user terminals, the selected image corresponding to the selected identification information based on the input operation for the image transmission on any one of the plurality of user terminals.

### CROSS-REFERENCE TO RELATED APPLICATIONS

This application claims the benefit of priority to Japanese Patent Application No. 2021-071097 filed on Apr. 20, 2021. The entire contents of this application are hereby incorporated herein by reference.

### BACKGROUND OF THE INVENTION

### Field of the Invention

The present invention relates to a measurement image management system, a measurement image management server, and a measurement image management method, and more particularly, it relates to a measurement image management system and a measurement image management server, both of which store a measurement image, and a measurement image management method including storing a measurement image.

### Description of the Background Art

Conventionally, a cell observation system that stores image data is known. Such a system is disclosed in Japanese Patent Laid-Open No. 2018-141695, for example.

A cell observation system described in Japanese Patent Laid-Open No. 2018-141695 includes an image processing server that stores image data obtained by imaging cells to be observed. This image processing server stores the image data together with identification information for identifying a measurement terminal that performs imaging, identification information of a cell culture plate, and attribute information including an imaging date and time.

Although not described in Japanese Patent Laid-Open No. 2018-141695, when the image processing server is configured to be able to communicate with a plurality of user terminals, a selected image selected by a user from among a plurality of pieces of image data (measurement images) stored in the server may be transmitted to the plurality of user terminals. In that case, in the cell observation system described in Japanese Patent Laid-Open No. 2018-141695, when the same selected image as a selected image (cell image) once selected by a first user is transmitted again to a user terminal of a second user, it is necessary for the second user to reselect the selected image from among the plurality of stored measurement images. In this case, it is necessary for the second user to reselect the correctly selected image. Therefore, when the selected image selected by the first user from among the plurality of measurement images is transmitted again to the user terminal of the second user, a reduction in the workload of acquiring the correctly selected image is desired.

### SUMMARY OF THE INVENTION

The present invention is intended to solve the above problem. The present invention aims to provide a measurement image management system, a measurement image management server, and a measurement image management method, each capable of reducing the workload of acquiring a correctly selected image when the selected image selected by a first user from among a plurality of measurement images and transmitted to a user terminal of the first user is transmitted again to a user terminal of a second user.

In order to attain the aforementioned object, a measurement image management system according to a first aspect of the present invention includes a server configured to store a plurality of measurement images acquired by a measurement device, and a plurality of user terminals configured to communicate with the server. The server includes an identification information acquirer configured to acquire identification information to identify, from the plurality of measurement images, a selected image selected based on an input operation for image selection on any one of the plurality of user terminals when the selected image selected from among the plurality of stored measurement images is transmitted to any one of the plurality of user terminals, a storage processor configured to store the identification information acquired by the identification information acquirer, a presentation processor configured to present the identification information stored by the storage processor to the plurality of user terminals such that the identification information is selectable, and a transmission processor configured to transmit, to a user terminal that has received an input operation for image transmission among the plurality of user terminals, the selected image corresponding to the selected identification information based on the input operation for the image transmission on any one of the plurality of user terminals to which the identification information has been presented, the input operation for the image transmission being performed separately from the input operation for the image selection.

A measurement image management server according to a second aspect of the present invention is configured to communicate with a plurality of user terminals and store a plurality of measurement images acquired by a measurement device, and includes an identification information acquirer configured to acquire identification information to identify, from the plurality of measurement images, a selected image selected based on an input operation for image selection on any one of the plurality of user terminals when the selected image selected from among the plurality of stored measurement images is transmitted to any one of the plurality of user terminals, a storage processor configured to store the identification information acquired by the identification information acquirer, a presentation processor configured to present the identification information stored by the storage processor to the plurality of user terminals such that the identification information is selectable, and a transmission processor configured to transmit, to a user terminal that has received an input operation for image transmission among the plurality of user terminals, the selected image corresponding to the selected identification information based on the input operation for the image transmission on any one of the plurality of user terminals to which the identification information has been presented, the input operation for the image transmission being performed separately from the input operation for the image selection.

A measurement image management method according to a third aspect of the present invention includes storing a plurality of measurement images acquired by a measurement device, acquiring identification information to identify, from the plurality of measurement images, a selected image selected based on an input operation for image selection on any one of a plurality of user terminals when the selected image selected from among the plurality of stored measurement images is transmitted to any one of the plurality of user terminals, storing the acquired identification information, presenting the stored identification information to the plurality of user terminals such that the identification information is selectable, and transmitting, to a user terminal that has received an input operation for image transmission among the plurality of user terminals, the selected image corresponding to the selected identification information based on the input operation for the image transmission on any one of the plurality of user terminals to which the identification information has been presented, the input operation for the image transmission being performed separately from the input operation for the image selection.

In the measurement image management system according to the first aspect, the measurement image management server according to the second aspect, and the measurement image management method according to the third aspect, the identification information is acquired to identify, from the plurality of measurement images, the selected image selected based on the input operation for the image selection on any one of the plurality of user terminals. Furthermore, the selected image corresponding to the selected identification information is transmitted to the user terminal that has received the input operation for the image transmission among the plurality of user terminals based on the input operation for the image transmission on any one of the plurality of user terminals to which the identification information has been presented, which is performed separately from the input operation for the image selection. Accordingly, when the selected image previously selected once by the input operation for the image selection and transmitted to one user terminal is transmitted to another user terminal again, the selected image corresponding to the identification information can be transmitted by selecting the identification information to identify the selected image from the plurality of measurement images. Therefore, when the same selected image is transmitted to each of the plurality of user terminals, a second user who uses another user terminal can acquire the previously selected image without making a mistake by selecting the stored identification information without reselecting the selected image from among the plurality of measurement images. Consequently, when the selected image selected by a first user from the plurality of measurement images and transmitted to the user terminal of the first user is transmitted to the user terminal of the second user again, the workload of acquiring the correctly selected image can be reduced.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating the configuration of a measurement image management system according to a first embodiment.

FIG. 2 is a block diagram illustrating the functional configuration of a server according to the first embodiment.

FIG. 3 is a diagram illustrating acquisition of captured images and characteristics information by an image acquirer.

FIG. 4 is a diagram illustrating creation of a data tree by a data tree creation unit.

FIG. 5 is a diagram illustrating a change in the order of the hierarchical structure of the data tree.

FIG. 6 is a diagram showing an example of a captured image according to the first embodiment.

FIG. 7 is a diagram illustrating selection of a selected image according to the first embodiment.

FIG. 8 is a diagram illustrating a compressed image according to the first embodiment.

FIG. 9 is a diagram illustrating acquisition of identification information according to the first embodiment.

FIG. 10 is a diagram illustrating list display of the identification information according to the first embodiment.

FIG. 11 is a diagram illustrating display of the progress degree of a compression process according to the first embodiment.

FIG. 12 is a diagram illustrating display of a transmission history according to the first embodiment.

FIG. 13 is a diagram illustrating storage of the compressed image in another system.

FIG. 14 is a flowchart illustrating a measurement image management method according to the first embodiment.

FIG. 15 is a block diagram illustrating the configuration of a measurement image management system according to a second embodiment.

FIG. 16 is a diagram illustrating list display of identification information according to the second embodiment.

FIG. 17 is a block diagram illustrating the configuration of a measurement image management system according to a third embodiment.

FIG. 18 is a diagram illustrating list display of identification information according to the third embodiment.

### DESCRIPTION OF THE PREFERRED EMBODIMENTS

Embodiments of the present invention are hereinafter described with reference to the drawings.

### First Embodiment

### Overall Configuration of Measurement Image Management System

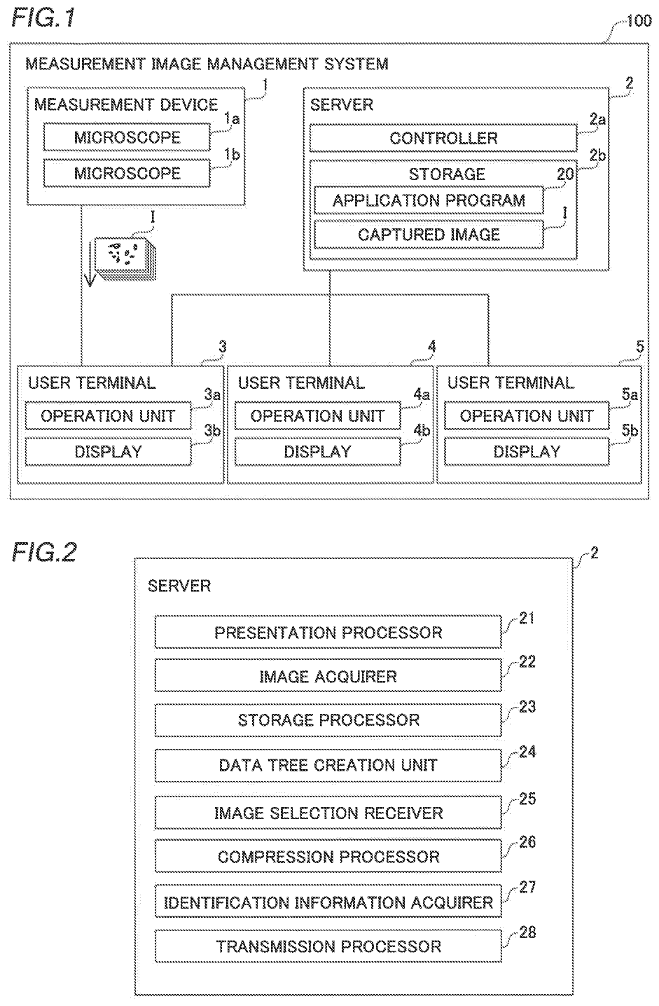

A measurement image management system 100 according to a first embodiment of the present invention is now described with reference to FIGS. 1 to 13.

As shown in FIG. 1, the measurement image management system 100 includes a measurement device 1, a server 2, a user terminal 3, a user terminal 4, and a user terminal 5. The server 2 is an example of a “measurement image management server” or a “server” in the claims. The user terminal 3, the user terminal 4, and the user terminal 5 are an example of a “plurality of user terminals”.

The measurement device 1 captures a plurality of captured images I (captured images I1, I2, I3, . . . (see FIG. 4)) by imaging cells to observe cell culture. The measurement device 1 includes a microscope 1a and a microscope 1b, for example. The microscopes 1a and 1b include phase-contrast microscopes or holographic microscopes, for example. The measurement device 1 captures the plurality of captured images I by imaging a plurality of wells in a cell culture plate including the wells. The wells are recesses in which cells are cultured. The measurement device 1 is connected to the user terminal 3. Furthermore, the measurement device 1 transmits the captured images I to the user terminal 3. The captured images I are examples of a “measurement image” or a “captured image” in the claims.

The server 2 is a computer built for a server, for example. The server 2 includes a controller 2a and a storage 2b. The controller 2a includes a central processing unit (CPU), a read-only memory (ROM), a random access memory (RAM), etc. The controller 2a controls each portion of the server 2 by executing a predetermined program with the CPU. The storage 2b includes a storage device such as a hard disk drive, for example. The storage 2b stores programs to activate the controller 2a. Specifically, the storage 2b stores application programs 20 to manage the captured images I. The application programs 20 operate by being executed by the controller 2a. Furthermore, the application programs 20 are web applications that operate in a web browser, for example. The storage 2b stores the captured images I. That is, in the first embodiment, the server 2 stores the plurality of captured images I acquired by the measurement device 1.

The user terminal 3 is a personal computer (PC), for example. The user terminal 3 is a computer device including a storage device such as a hard disk drive and an arithmetic device such as a CPU. The user terminal 3 includes an operation unit 3a and a display 3b. The operation unit 3a includes an input such as a keyboard and a pointing device such as a mouse. The operation unit 3a receives an operation signal to operate each portion of the user terminal 3. The operation unit 3a transmits, to the arithmetic device of the user terminal 3, an operation signal based on an input operation. The display 3b includes a display monitor such as a liquid crystal display. The display 3b provides a display controlled by the arithmetic device of the user terminal 3.

The user terminals 4 and 5 are personal computers (PCs) having the same configuration as the user terminal 3. That is, the user terminals 4 and 5 include operation units 4a and 5a and displays 4b and 5b, respectively. The operation units 4a and 5a have the same configuration as the operation unit 3a. The displays 4b and 5b have the same configuration as the display unit 3b. In the first embodiment, the user terminals 3 to 5 are configured to be able to communicate with the server 2. The user terminals 3 to 5 communicate with the server 2 by a local area network (LAN), for example.

The user terminal 3 is connected to the measurement device 1. The user terminal 3 acquires the plurality of captured images I captured by the measurement device 1. The user terminals 4 and 5 are not connected to the measurement device 1, for example. In the measurement image management system 100 according to the first embodiment, as an example, the plurality of captured images I transmitted (uploaded) to the server 2 by the user terminal 3 are transmitted (downloaded) to the user terminals 4 and 5.

### Measurement Image Management by Server

As shown in FIG. 2, in the first embodiment, the server 2 includes a presentation processor 21, an image acquirer 22, a storage processor 23, a data tree creation unit 24, an image selection receiver 25, a compression processor 26, an identification information acquirer 27, and a transmission processor 28 as functional configurations. Specifically, the controller 2a of the server 2 executes the application programs 20 stored in the storage 2b to function as the presentation processor 21, the image acquirer 22, the storage processor 23, the data tree creation unit 24, the image selection receiver 25, the compression processor 26, the identification information acquirer 27, and the transmission processor 28.

The presentation processor 21 (controller 2a) provides displays by the application programs 20 on the displays 3b to 5b of the user terminals 3 to 5. Specifically, the presentation processor 21 transmits, to the user terminals 3 to 5, display information to provide the displays by the application programs 20. The user terminals 3 to 5 provide the displays by the application programs 20 on the displays 3b to 5b based on the display information from the presentation processor 21.

### Storage of Captured Images

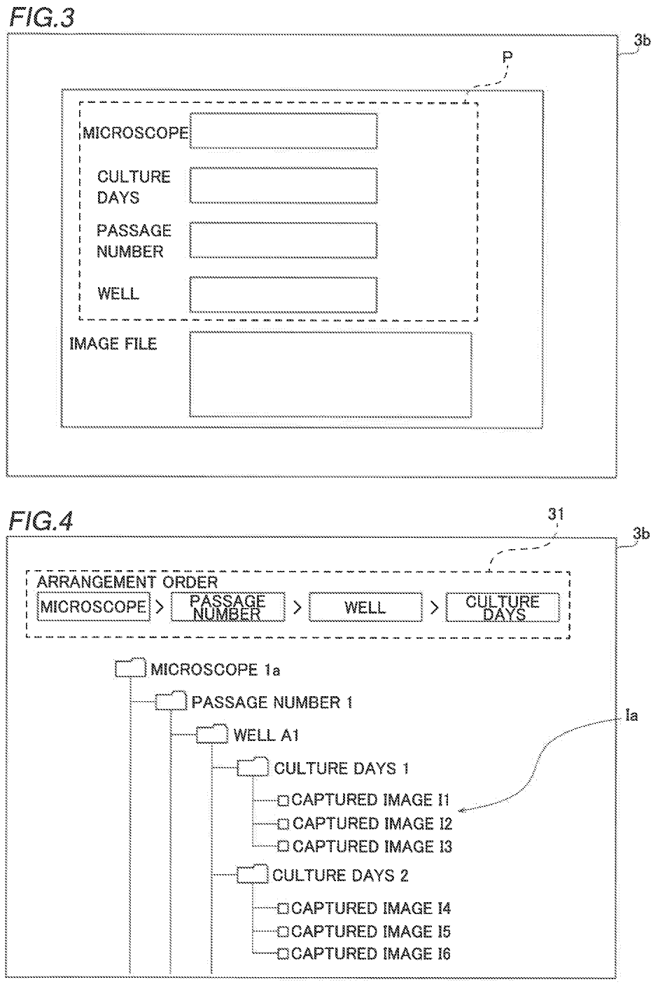

As shown in FIG. 3, the image acquirer 22 (controller 2a) acquires the plurality of captured images I captured by the measurement device 1. Furthermore, the image acquirer 22 acquires characteristics information P indicating a measurement device 1 (the identification number information of the microscopes 1a and 1b), a cell culture period of time (culture days), a cell passage number, and a well (well number), which is a recess in which a cell is cultured, for each of the acquired captured images I.

Specifically, the captured images I and the characteristics information P are associated with each other and transmitted to the server 2 from the user terminal 3 that has acquired the plurality of captured images I. The characteristics information P is acquired based on an input operation on the operation unit 3a of the user terminal 3. When the application programs 20 of the server 2 are executed on the user terminal 3 via the web browser, screen display for inputting the characteristics information P is presented (transmitted) to the user terminal 3 by the presentation processor 21 and displayed on the display 3b. A user who uses the user terminal 3 performs an input operation on the operation unit 3a while referring to the display of the display 3b such that the characteristics information P is input. The input characteristics information P and the captured images I are transmitted from the user terminal 3 to the server 2. Then, the image acquirer 22 of the server 2 acquires the captured images I and the characteristics information P transmitted from the user terminal 3.

The storage processor 23 (controller 2a) associates the captured images I acquired by the image acquirer 22 with the characteristics information P and stores the captured images I in the storage 2b. That is, in the first embodiment, the server 2 is configured to associate the plurality of captured images I with the characteristics information P and store the plurality of captured images I.

As shown in FIG. 4, in the first embodiment, the data tree creation unit 24 (controller 2a) of the server 2 creates a data tree Ia by grouping captured images I having common characteristics among the plurality of captured images I into the same group. That is, the data tree creation unit 24 creates the data tree Ia such that the captured images I having the common characteristics information P are in the same group (folder). Furthermore, the data tree creation unit 24 creates the data tree Ia having a hierarchical structure with a plurality of hierarchies corresponding to each of a plurality of types of characteristics information P. For example, the data tree creation unit 24 sets the measurement device 1 (the identification number information of the microscopes 1a and 1b) in a hierarchy having a higher arrangement order.

Then, the data tree creation unit 24 sets the passage number in the next hierarchy. In that case, the captured images I are grouped according to the type (microscope 1a or 1b) of measurement device 1 used to capture the captured images I, and then the captured images I are further grouped according to the number of passage numbers. Thus, the data tree creation unit 24 sets the arrangement order (priority) for each of a plurality of pieces of characteristics information P, and performs grouping in stages for each characteristics information P in the set arrangement order to create the data tree Ia having a hierarchical structure. Then, the presentation processor 21 displays the data tree Ia created by the data tree creation unit 24 on the display 3b of the user terminal 3. The presentation processor 21 (controller 2a) presents the captured images I stored in the server 2 such that the captured images I are selectable by transmitting the data tree Ia to the user terminal 3 and displaying it on the display 3b.

As shown in FIG. 5, the data tree creation unit 24 (controller 2a) can change the arrangement order of the hierarchical structure of the data tree Ia. Specifically, an indication indicating the arrangement order of the hierarchical structure that is displayed in a region 31 (see FIGS. 4 and 5) of the display 3b is changed based on an input operation on the user terminal 3 on which the data tree Ia is displayed such that the data tree creation unit 24 changes the arrangement order of the hierarchical structure of the data tree Ia. Furthermore, the data tree creation unit 24 deletes a portion of the arrangement order of the hierarchical structure and changes the arrangement order of the hierarchical structure. The presentation processor 21 displays the changed data tree Ia on the display 3b of the user terminal 3.

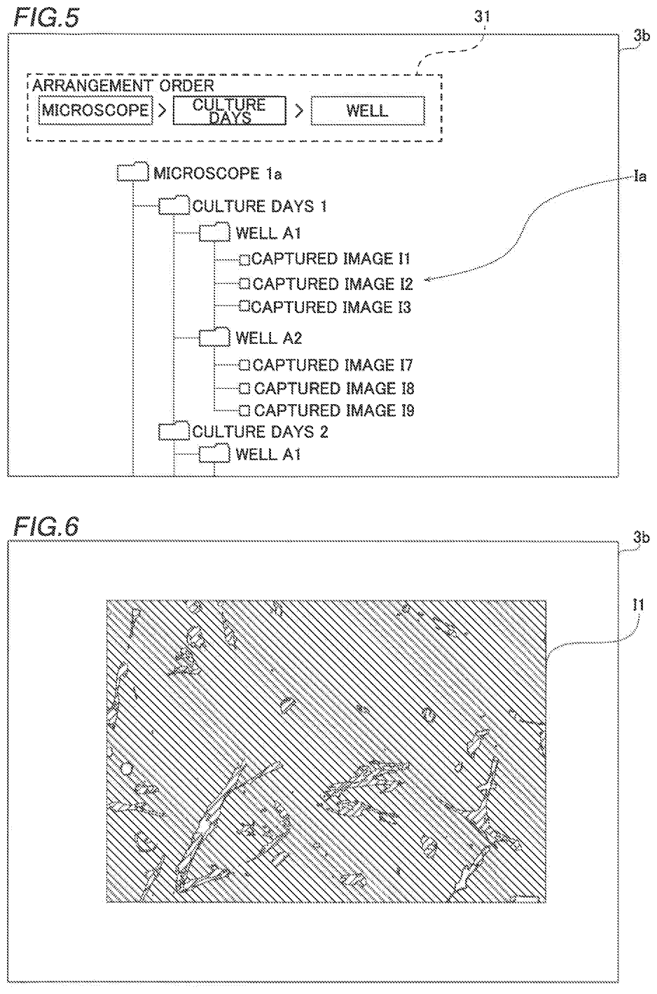

As shown in FIG. 6, the presentation processor 21 (controller 2a) displays the captured images I stored in the server 2 on the display 3b of the user terminal 3. Specifically, when the captured image I1 is selected, for example, from the plurality of captured images I of the data tree Ia based on an input operation on the operation unit 3a of the user terminal 3, the presentation processor 21 displays the captured image I1 on the display 3b.

The presentation processor 21 also displays the data tree Ia on each of the user terminals 4 and 5 in the same manner based on input operations on the operation unit 4a and the operation unit 5a.

### Selection of Selected Images

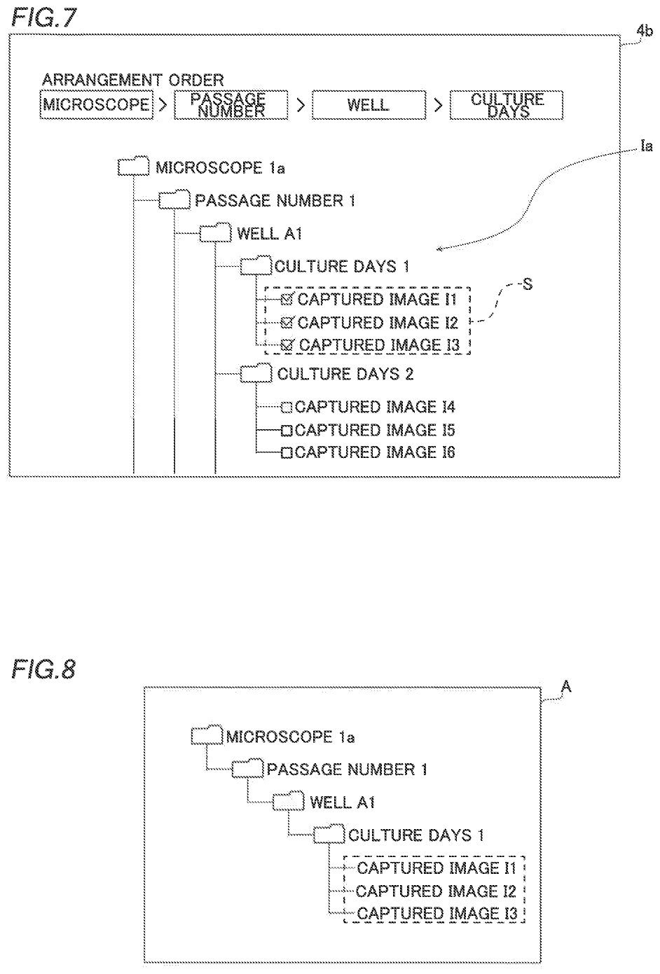

The measurement image management system 100 according to the first embodiment can select selected images S (see FIG. 7) to be transmitted to the user terminals 4 and 5 from among the plurality of captured images I stored in the server 2. The measurement image management system 100 stores the selected images S in the server 2 such that they can be identified from the plurality of captured images I. In the first embodiment, as an example, the selected images S selected based on an input operation on the user terminal 4 are transmitted to the user terminals 4 and 5.

As shown in FIG. 7, in the first embodiment, the image selection receiver 25 (controller 2a) receives an image selection in which a plurality of selected images S are selected from among the plurality of captured images I based on the input operation for image selection on the user terminal 4. For example, the image selection receiver 25 receives an image selection of the selected images S to be transmitted to the user terminal 4 from among the plurality of captured images I based on the input operation on the operation unit 4a of the user terminal 4. Specifically, from the data tree Ia presented by the presentation processor 21 and displayed on the display 4b, the plurality of selected images S are selected based on a click operation on the operation unit 4a, for example. Also regarding the selected images S, the data tree Ia is maintained such that the selected images S having common characteristics (characteristics information P) are in the same group. That is, the data tree creation unit 24 creates the data tree Ia by grouping the selected images S having common characteristics (characteristics information P) into the same group also for the plurality of selected images S.

As shown in FIG. 8, in the first embodiment, the compression processor 26 (controller 2a) generates a compressed image A (archive), which is a plurality of selected images S compressed by performing a compression process on the plurality of selected images S based on the input operation on the operation unit 4a of the user terminal 4. Furthermore, the compression processor 26 performs the compression process on the plurality of selected images S including the data tree Ia created by the data tree creation unit 24.

That is, the compression processor 26 compresses the selected images S such that the compressed image A is stored in the folder so as to have a hierarchical structure in the same arrangement order as that of the data tree Ia created by the data tree creation unit 24, and generates the compressed image A. Then, the storage processor 23 stores the generated compressed image A in the storage 2b.

### Identification Information

In the measurement image management system 100 according to the first embodiment, the server 2 acquires the generated compressed image A and identification information Q for identifying the selected images S included in the compressed image A from the plurality of captured images I. Then, the server 2 stores the compressed image A and the identification information Q in the storage 2b in association with each other.

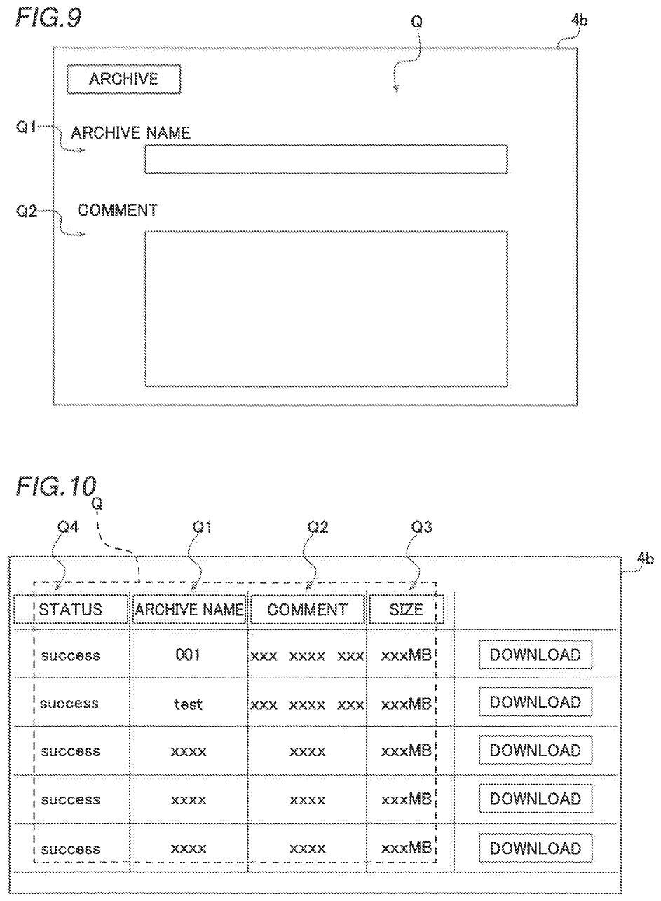

As shown in FIG. 9, in the first embodiment, the identification information acquirer 27 (controller 2a) acquires the identification information Q based on the input operation for image selection on the user terminal 4. Specifically, in the first embodiment, the identification information acquirer 27 acquires the identification information Q including name information Q1 (archive name) indicating the selected images S (compressed image A) and comment information Q2 on the selected images S (compressed image A). More specifically, when the compression process is performed on the selected images S, the identification information acquirer 27 acquires the identification information Q including the name information Q1 and the comment information Q2 based on the input operation on the operation unit 4a. For example, when an operation to start the compression process is received with the input of the name information Q1 and the comment information Q2 based on the input operation on the operation unit 4a being completed, the identification information acquirer 27 acquires the identification information Q including the name information Q1 and the comment information Q2.

In the first embodiment, the identification information acquirer 27 (controller 2a) acquires the identification information Q including the capacities Q3 (see FIG. 10) of the selected images S (compressed image A) based on the selected images S. Specifically, the identification information acquirer 27 acquires the capacity Q3 (file size) of the compressed image A generated by the compression processor 26 as the identification information Q. In the first embodiment, the storage processor 23 stores the identification information Q (the name information Q1, the comment information Q2, and the capacities Q3) acquired by the identification information acquirer 27 and the compressed image A corresponding to the identification information Q in the storage 2b in association with each other.

The identification information acquirer 27 acquires status information Q4. The status information Q4 is information indicating whether or not the compression process by the compression processor 26 has succeeded. The storage processor 23 associates the status information Q4 with the compressed image A and stores it in the storage 2b.

As shown in FIG. 10, in the first embodiment, the presentation processor 21 presents the identification information Q stored by the storage processor 23 to the user terminal 4 such that the identification information Q is selectable. For example, in the first embodiment, the presentation processor 21 is configured to display the name information Q1, the comment information Q2, the capacities Q3 of the selected images S, and the status information Q4 on the display 4b of the user terminal 4.

In the first embodiment, the server 2 stores a plurality of pieces of identification information Q in the storage 2b with the storage processor 23. For example, the presentation processor 21 is configured to display a list of the plurality of pieces of identification information Q stored in the server 2 side by side on the display 4b of the user terminal 4 such that the plurality of pieces of identification information Q are selectable.

Then, the transmission processor 28 transmits, to the user terminal 4, the stored compressed image A corresponding to one selected from among the plurality of pieces of identification information Q listed side by side based on a selection on the displayed identification information Q. Specifically, in the first embodiment, the transmission processor 28 transmits, to the user terminal 4, the selected images S (compressed image A) based on an input operation for image transmission on the operation unit 4a of the user terminal 4.

When the selected images S, which are the selected captured images I, are transmitted to the user terminal 4 as described above, first, the selected images S are selected from among the plurality of captured images I stored in the storage 2b of the server 2 based on the input operation for image transmission on the user terminal 4, and the compressed image A in which the selected images S have been collectively compressed and the identification information Q are associated with each other and stored in the storage 2b. That is, in the first embodiment, the identification information acquirer 27 (controller 2a) acquires the identification information Q based on the input operation for image selection on the user terminal 4 when the selected images S selected from among the plurality of captured images I stored in the storage 2b are transmitted to the user terminal 4.

### Transmission of Compressed Image to Plurality of User Terminals

The measurement image management system 100 according to the first embodiment can transmit, to a plurality of user terminals 3 and 5 different from the user terminal 4 that has received the input operation for image selection, the same compressed image A (selected images S) as the compressed image A (selected images S) transmitted to the user terminal 4.

In the first embodiment, the presentation processor 21 presents the identification information Q stored by the storage processor 23 to the plurality of user terminals 3 to 5 such that the identification information Q is selectable. That is, the presentation processor 21 displays a list of a plurality of pieces of stored identification information Q side by side in the same manner not on only the user terminal 4 that has received the input operation for image selection to select the selected images S, but on a plurality of user terminals 3 to 5 such that the plurality of pieces of identification information Q are selectable. In the first embodiment, the transmission processor 28 transmits, to a user terminal that has received an input operation for image transmission among the plurality of user terminals 3 to 5, the selected images S (compressed image A) corresponding to the selected identification information Q based on the input operation for image transmission on any one of the plurality of user terminals 3 to 5 to which the identification information Q has been presented, which is performed separately from an input operation for image selection.

For example, when the user terminal 5 receives a selection operation (an input operation for image transmission of the compressed image A) on a plurality of pieces of identification information Q displayed on the display 5b of the user terminal 5 separately from an input operation (an input operation for a compression process) for image selection received by the user terminal 4, the transmission processor 28 transmits, to the user terminal 5, the compressed image A corresponding to the selected identification information Q. That is, the transmission processor 28 transmits the selected images S (compressed image A) selected based on the input operation for image selection on the user terminal 4 to the user terminal 5 that has received the input operation for image transmission.

Compression Process from Plurality of User Terminals

In the measurement image management system 100 according to the first embodiment, the input operation for image selection to select the selected images S (an input operation for performing the compression process to generate the compressed image A) can be received by any of the plurality of user terminals 3 to 5. That is, in the first embodiment, the compression processor 26 performs the compression process for each of input operations for image selection on the plurality of user terminals 3 to 5 based on the input operation for image selection on each of the plurality of user terminals 3 to 5.

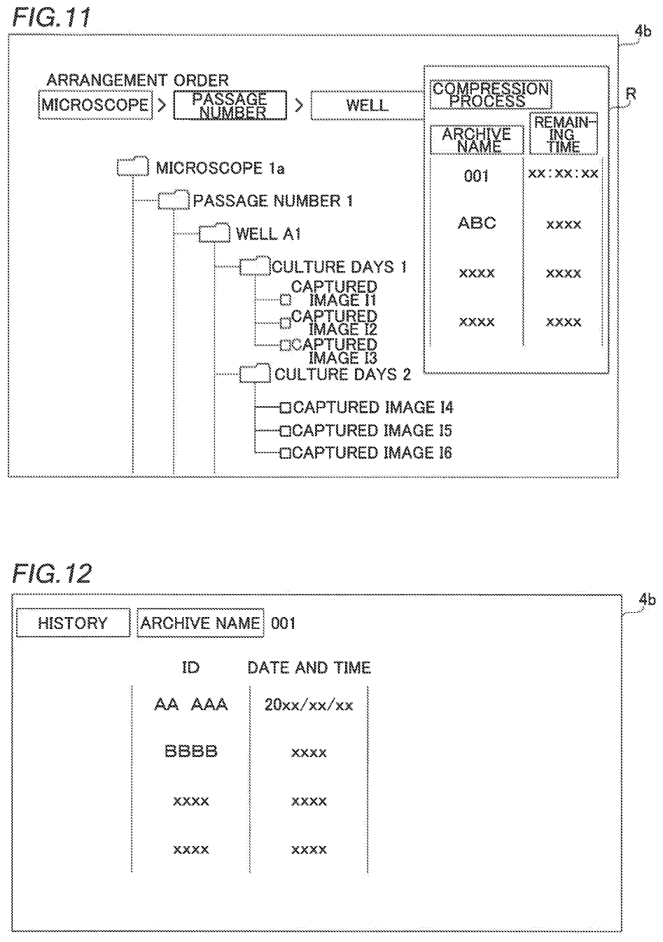

Then, as shown in FIG. 11, the presentation processor 21 displays the progress degree R of each of a plurality of compression processes performed by the compression processor 26 on the plurality of user terminals 3 to 5. For example, the presentation processor 21 visually displays the remaining time of the compression process currently being performed.

In the first embodiment, the compression processor 26 performs the compression process on the plurality of selected images S by an asynchronous process in which a plurality of processes are performed in parallel. Therefore, in the first embodiment, the image selection receiver 25 can receive an image selection in which new selected images S are selected while the compression processor 26 is performing the compression process. For example, when the input operation for image selection is received and the compression process is started in the user terminal 4, the presentation processor 21 displays the data tree Ia and the progress degree R on the display 4b of the user terminal 4 while the compression process is being performed. Therefore, the compression processor 26 can perform the compression process on the new selected images S even while the compression process is being performed.

In the first embodiment, the storage processor 23 deletes the stored identification information Q when a predetermined period of time elapses from the time at which the identification information Q is stored, or when the number of pieces of stored identification information Q exceeds a predetermined number. For example, the storage processor 23 deletes the stored identification information Q and compressed image A from the storage 2b when a period of one week elapses from the time at which the identification information Q is stored. Furthermore, for example, the storage processor 23 deletes the oldest identification information Q and the compressed image A when the number of pieces of stored identification information Q (the number of compressed images A) exceeds twenty.

As shown in FIG. 12, in the first embodiment, the presentation processor 21 displays, on the plurality of user terminals 3 to 5, the transmission history information of the selected images S (compressed image A) to each of the plurality of user terminals 3 to 5. For example, the presentation processor 21 displays the transmission history of the compressed image A corresponding to the identification information Q on the display 4b based on an input operation on the operation unit 4a of the user terminal 4. Furthermore, the presentation processor 21 displays the transmission history for each identification information Q, for example. The presentation processor 21 displays, on the display 4b, ID information for identifying the user terminals 3 to 5 to which the compressed image A has been transmitted and the transmission date and time as the transmission history.

Cooperation with Another System

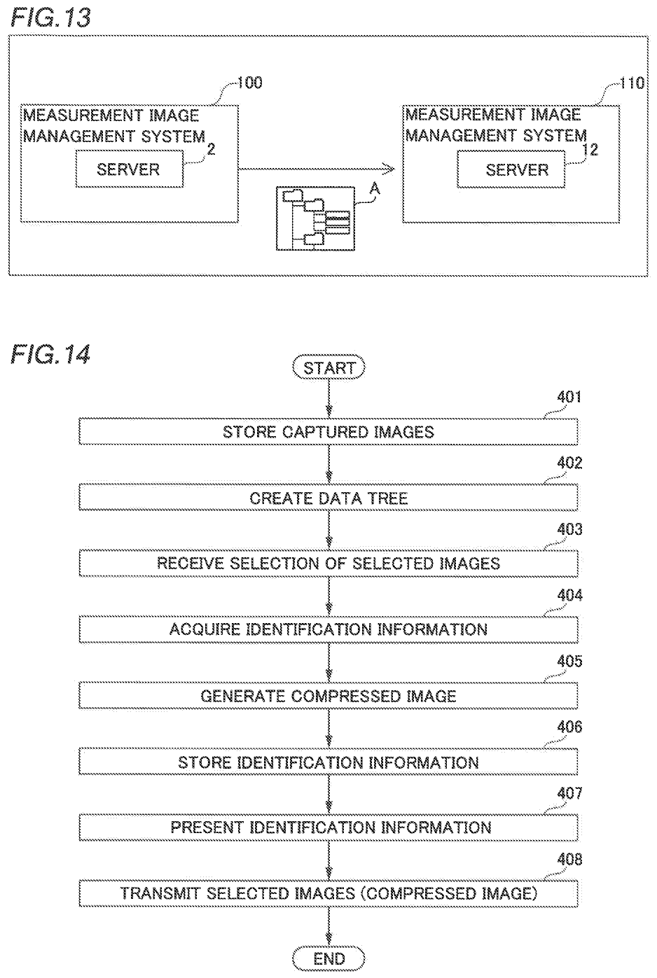

As shown in FIG. 13, the measurement image management system 100 can use data common to a measurement image management system 110 including a server 12 separate from the server 2. The measurement image management system 110 has the same or similar configuration as that of the measurement image management system 100. In the first embodiment, the transmission processor 28 transmits, to the user terminal 3, 4, or 5 that has received the input operation for image transmission, the selected images S (compressed image A) and the characteristics information P in association with each other to enable storage of the selected images S and the characteristics information P in the server 12 separate from the server 2 configured to store the captured images I in association with the characteristics information P.

Specifically, when the compression processor 26 of the server 2 compresses the selected images S so as to include the characteristics information P stored in association with the selected images S (selected captured images I) to generate the compressed image A when performing the compression process on the selected images S. Then, the server 12, which is separate from the server 2, stores the selected images S of the compressed image A as the captured images I in association with the characteristics information P based on the compressed image A (selected images S) generated by the server 2. Similarly, the server 2 can store a compressed image (selected images) generated in a server separate from the server 2 as the captured images I. Specifically, as described above, the compression processor 26 of the server 2 according to the first embodiment generates the compressed image A including a hierarchical structure corresponding to the type of characteristics information P. When the compressed image A is acquired, the server 12 stores the selected images S (captured images I) included in the compressed image A while maintaining the hierarchical structure (data tree Ia) included in the compressed image A. That is, the server 2 and the server 12 can store the captured images I and the characteristics information P in association with each other based on the hierarchical structure (folder division) of the acquired compressed image A.

### About Measurement Image Management Method According to First Embodiment

A control process flow regarding a measurement image management method by the measurement image management system 100 according to the first embodiment is now described with reference to FIG. 14. The control process of the measurement image management method by the measurement image management system 100 is performed by the server 2.

First, in step 401, the plurality of captured images I acquired (captured) by the measurement device 1 are stored. Specifically, the plurality of captured images I are stored in association with the characteristics information P.

Then, in step 402, the data tree Ia is created in which the captured images I having common characteristics (characteristics information P) are grouped into the same group.

Then, in step 403, a selection of the selected images S is received. Specifically, a selection of the selected images S selected from among the plurality of stored captured images I is received based on the input operation for image selection on the user terminal 4, which is one of the plurality of user terminals 3 to 5.

Then, in step 404, when the selected images S are transmitted to the user terminal 4 (any one of the plurality of user terminals 3 to 5), the identification information Q for identifying the selected images S from the plurality of captured images I is acquired.

Then, in step 405, the compression process is performed on the plurality of selected images S to generate the compressed image A, which is the plurality of compressed selected images S.

Then, in step 406, the acquired identification information Q is stored. Specifically, the identification information Q and the compressed image A are stored in association with each other.

Then, in step 407, the stored identification information Q is presented to the plurality of user terminals 3 to 5 such that the stored identification information Q is selectable.

Then, in step 408, the selected images S (compressed image A) corresponding to the selected identification information Q is transmitted to the user terminal 5 that has received the input operation for image transmission among the plurality of user terminals 3 to 5 based on the input operation for image transmission on the user terminal 5 (any one of the plurality of user terminals 3 to 5) to which the identification information Q has been presented, which is performed separately from the input operation for image selection on the user terminal 4.

### Advantages of First Embodiment

According to the first embodiment, the following advantages are obtained.

As described above, the measurement image management system 100 and the server 2 (measurement image management server) according to the first embodiment acquire the identification information Q to identify, from the plurality of captured images I (measurement images), the selected images S selected based on the input operation for image selection on any one of the plurality of user terminals 3 to 5. Furthermore, the measurement image management system 100 and the server 2 transmit, to the user terminal that has received the input operation for image transmission among the plurality of user terminals 3 to 5, the selected images S corresponding to the selected identification information Q based on the input operation for image transmission on any one of the plurality of user terminals 3 to 5 to which the identification information Q has been presented, which is performed separately from the input operation for image selection. Accordingly, when the selected images S previously selected once by the input operation for image selection and transmitted to one user terminal 4 are transmitted to another user terminal 5 again, the selected images S corresponding to the identification information Q can be transmitted by selecting the identification information Q to identify the selected images S from the plurality of captured images I. Therefore, when the same selected images S are transmitted to each of the plurality of user terminals 3 to 5, a second user who uses another user terminal 5 can acquire the previously selected images S without making a mistake by selecting the stored identification information Q without reselecting the selected images S from among the plurality of captured images I. Consequently, when the selected images S selected by a first user from the plurality of captured images I and transmitted to the user terminal 4 of the first user are transmitted to the user terminal 5 of the second user again, the workload of acquiring the correctly selected images S can be reduced.

According to the first embodiment, with the following configurations, the following advantages are further obtained.

That is, according to the first embodiment, as described above, the server 2 is configured to store the plurality of pieces of identification information Q by the storage processor 23, the presentation processor 21 is configured to display a list of the plurality of pieces of identification information Q stored in the server 2 side by side on the plurality of user terminals 3 to 5 such that the plurality of pieces of identification information Q are selectable, and the transmission processor 28 is configured to transmit, to the user terminal 5 that has received the input operation for image transmission, the selected images S corresponding to one selected from among the plurality of pieces of identification information Q listed side by side on the plurality of user terminals 3 to 5 based on the input operation for image transmission. Accordingly, the plurality of pieces of identification information Q are listed side by side, and thus the second user who reacquires the selected images S previously selected by the first user can easily select one from the plurality of pieces of identification information Q. Therefore, even when the plurality of pieces of identification information Q are stored in the server 2, one necessary identification information Q can be easily selected, and thus the necessary selected images S can be easily acquired. Consequently, even when the plurality of pieces of identification information Q are stored in the server 2, the correctly selected images S can be easily acquired, and thus the workload of acquiring the correctly selected images S can be reduced.

According to the first embodiment, as described above, the server 2 includes the image selection receiver 25 configured to receive an image selection to select the plurality of selected images S from among the plurality of captured images I (measurement images) based on the input operation for image selection on any one of the plurality of user terminals 3 to 5, and the compression processor 26 configured to generate the compressed image A, which is the plurality of selected images S compressed by performing the compression process on the plurality of selected images S. Furthermore, the storage processor 23 is configured to store the identification information Q and the compressed image A corresponding to the identification information Q in association with each other. When the plurality of selected images S are transmitted from the server 2 to any one of the user terminals 3 to 5, the compression process is generally performed on the plurality of selected images S to generate one compressed file (compressed image A), and one generated compressed image A is transmitted. In this case, when the plurality of selected images S selected by the first user and transmitted to the user terminal 4 of the first user are transmitted to another user terminal 5 again, it is necessary to perform the compression process each time the plurality of selected images S are reselected. On the other hand, in the first embodiment, the storage processor 23 is configured to store the identification information Q and the compressed image A corresponding to the identification information Q in association with each other. Accordingly, the compressed image A in which the plurality of selected images S have been compressed is stored in association with the identification information Q, and thus when the second user selects the identification information Q and reacquires the plurality of selected images S, the compressed image A compressed in advance can be acquired. Therefore, it is not necessary to perform the compression process to compress the plurality of selected images S each time the second user reacquires the plurality of selected images S, and thus the work time (processing time) required to reacquire the plurality of selected images S can be reduced. Consequently, when the selected images S selected by the first user from among the plurality of captured images I and transmitted to the user terminal 4 of the first user are transmitted to the user terminal 5 of the second user, the correctly selected images S can be acquired more easily, and thus the workload of acquiring the correctly selected images S can be further reduced.

According to the first embodiment, as described above, the compression processor 26 is configured to perform the compression process for each input operation for image selection on the plurality of user terminals 3 to 5 based on the input operation for image selection on each of the plurality of user terminals 3 to 5, and the presentation processor 21 is configured to display the progress degree R of each of the plurality of compression processes performed by the compression processor 26 on the plurality of user terminals 3 to 5. Accordingly, when the plurality of selected images S are selected and the compression process is performed, the progress degree R of each of the plurality of compression processes currently being performed can be confirmed. Therefore, each of a plurality of users who use the plurality of user terminals 3 to 5, respectively, can easily recognize the timing at which the compression process being performed by himself or herself is completed by visually recognizing each of the user terminals 3 to 5.

According to the first embodiment, as described above, the compression processor 26 is configured to perform the compression process on the plurality of selected images S by the asynchronous process in which a plurality of processes are performed in parallel, and the image selection receiver 25 is configured to receive an image selection to select new selected images S while the compression process is being performed by the compression processor 26. Accordingly, even while the compression process is being performed by the compression processor 26 based on the input operation received by the user terminal 4 of the first user, the image selection receiver 25 can receive a new image selection based on an input operation on the user terminal 4, and thus the first user can easily select a different type of selected images S a plurality of times unlike a case in which a new image selection is not received while the compression process is being performed. Therefore, when a different type of selected images S is selected a plurality of times, an increase in the required work time can be significantly reduced or prevented.

According to the first embodiment, as described above, the server 2 includes the data tree creation unit 24 configured to create the data tree Ia by grouping the plurality of selected images S such that the selected images S having the common characteristics are in the same group, and the compression processor 26 is configured to perform the compression process on the plurality of selected images S including the data tree Ia created by the data tree creation unit 24. Accordingly, the compression process is performed on the plurality of selected images S including the created data tree Ia, and thus when the plurality of selected images S are transmitted from the server 2 to any one of the plurality of user terminals 3 to 5, the plurality of selected images S grouped (divided into folders) based on the created data tree Ia can be transmitted to any one of the plurality of user terminals 3 to 5. Therefore, as compared with a case in which the plurality of selected images S are stored in one folder, the selected images S having the common characteristics are grouped into the same group (folder) such that the necessary selected images S can be more easily selected from among the plurality of selected images S. Consequently, the time and effort required for the user who has acquired the compressed image A in which the plurality of selected images S have been compressed to search for the necessary selected image S can be significantly reduced or prevented.

According to the first embodiment, as described above, the server 2 is configured to store the plurality of captured images I (measurement images) acquired by imaging cells with the microscopes 1a and 1b to observe cell culture in association with the characteristics information P indicating at least one of the cell culture period of time, the measurement device 1, or the well, which is a recess in which a cell is cultured, and the storage processor 23 is configured to store the identification information Q to identify, from the plurality of captured images I, the selected images S selected from among the plurality of captured images I. Accordingly, even when the selected images S previously selected once from among the plurality of captured images I captured to observe the cultured cells and transmitted to one user terminal 4 are reselected, the second user can easily acquire the selected images S selected by the first user by selecting the stored identification information Q. Therefore, when the selected images S selected from among the plurality of captured images I acquired by imaging the cells are transmitted to another user terminal 5 again, the correctly selected images S can be easily acquired. Furthermore, the plurality of captured images I are stored in association with the characteristics information P such that the necessary selected images S can be selected based on the characteristics information P stored in association with the captured images I. Therefore, the characteristics information P is stored in association with the plurality of captured images I such that the selected images S can be more easily selected from among the captured images I of the cells, and thus when the necessary selected images S are selected from among the plurality of captured images I acquired by imaging the cells, the time and effort required for the selection work can be reduced.

According to the first embodiment, as described above, the transmission processor 28 is configured to transmit, to the user terminal 3, 4, or 5 that has received the input operation for image transmission, the selected images S (compressed image A) and the characteristics information P in association with each other to enable storage of the selected images S and the characteristics information P in the server 12 separate from the server 2 configured to store the captured images I (measurement images) in association with the characteristics information P. Accordingly, the selected images S and the characteristics information P are transmitted in association with each other to enable storage of the selected images S and the characteristics information P in the separate server 12, and thus when the selected images S transmitted to the user terminal (any one of the plurality of user terminals 3 to 5) that has received the input operation for image transmission are stored in the separate server 12, the selected images S can be easily stored in association with the characteristics information P. Therefore, when the selected images S acquired in the user terminal that has received the input operation for image transmission are stored in the separate server 12, the selected images S and the characteristics information P can be easily stored in the separate server 12 in association with each other without performing the input work to associate the characteristics information P corresponding to the selected images S. Consequently, in the separate server 12, the workload of storing the acquired selected images S in association with the characteristics information P can be reduced.

According to the first embodiment, as described above, the identification information acquirer 27 is configured to acquire the identification information Q including at least one of the capacity Q3 of the compressed image A (selected images S), the number of selected images S, or the image file names of the selected images S based on the selected images S, and the presentation processor 21 is configured to display at least one of the capacity Q3 of the compressed image A (selected images S), the number of selected images S, or the image file names on the plurality of user terminals 3 to 5. Accordingly, at least one of the capacity Q3 of the compressed image A (selected images S) corresponding to the selected images S selected by the first user, the number of selected images S, or the image file names can be displayed on another user terminal 5, and thus the second user can select the identification information Q while referring to at least one of the displayed capacity Q3 of the selected images S, the displayed number of selected images S, or the displayed image file names. Therefore, when the identification information Q is selected and the selected images S are transmitted from the server 2 to the user terminal 5 of the second user, the identification information Q corresponding to the necessary selected images S can be more easily selected. Thus, the time and effort required for the selection work to select the necessary selected images S can be further reduced.

According to the first embodiment, as described above, the presentation processor 21 is configured to display, on the plurality of user terminals 3 to 5, the transmission history information of the selected images S to each of the plurality of user terminals 3 to 5. Accordingly, it is possible to recognize whether or not the transmission of the selected images S to each of the plurality of user terminals 3 to 5 is completed, and thus when the transmission of the selected images S to the user terminal to which the selected images S need to be transmitted among the plurality of user terminals 3 to 5 is all completed, the stored identification information Q can be deleted. Therefore, a shortage of the storage capacity of the server 2 due to storage of the unnecessary identification information Q for a long period of time can be significantly reduced or prevented. Furthermore, it is possible to identify a user terminal to which transmission of the selected images S is not completed from user terminals to which the selected images S need to be transmitted among the plurality of user terminals 3 to 5, and thus a user who uses the user terminal to which transmission of the selected images S is not completed can be prompted to acquire the selected images S. Therefore, the transmit leakage to the user terminals to which the selected images S need to be transmitted among the plurality of user terminals 3 to 5 can be significantly reduced or prevented.

According to the first embodiment, as described above, the storage processor 23 is configured to delete the stored identification information Q when the predetermined period of time elapses from the time at which the identification information Q is stored, or when the number of pieces of stored identification information Q exceeds the predetermined number. Accordingly, the identification information Q is automatically deleted by the storage processor 23, and thus continuous storage of the unnecessary identification information Q for a long period of time can be easily significantly reduced or prevented. Therefore, a shortage of the storage capacity of the server 2 due to storage of the unnecessary identification information Q can be easily significantly reduced or prevented.

### Advantages of Measurement Image Management Method According to First Embodiment

In the measurement image management method according to the first embodiment, the following advantages are obtained.

In the measurement image management method according to the first embodiment, with the configurations described above, the identification information Q is acquired to identify, from the plurality of captured images I (measurement images), the selected images S selected based on the input operation for image selection on any one of the plurality of user terminals 3 to 5. Furthermore, the selected images S corresponding to the selected identification information Q are transmitted to the user terminal that has received the input operation for image transmission among the plurality of user terminals 3 to 5 based on the input operation for image transmission on any one of the plurality of user terminals 3 to 5 to which the identification information Q has been presented, which is performed separately from the input operation for image selection. Thus, when the selected images S previously selected once by the input operation for image selection and transmitted to one user terminal 4 are transmitted to another user terminal 5 again, the selected images S corresponding to the identification information Q can be transmitted by selecting the identification information Q to identify the selected images S from the plurality of captured images I. Therefore, when the same selected images S are transmitted to each of the plurality of user terminals 3 to 5, the second user who uses another user terminal 5 can acquire the previously selected images S without making a mistake by selecting the stored identification information Q without reselecting the selected images S from among the plurality of captured images I. Consequently, it is possible to provide the measurement image management method capable of reducing the workload of acquiring the correctly selected images S when the selected images S selected by the first user from among the plurality of captured images I and transmitted to the user terminal 4 of the first user are transmitted to the user terminal 5 of the second user again.

### Second Embodiment

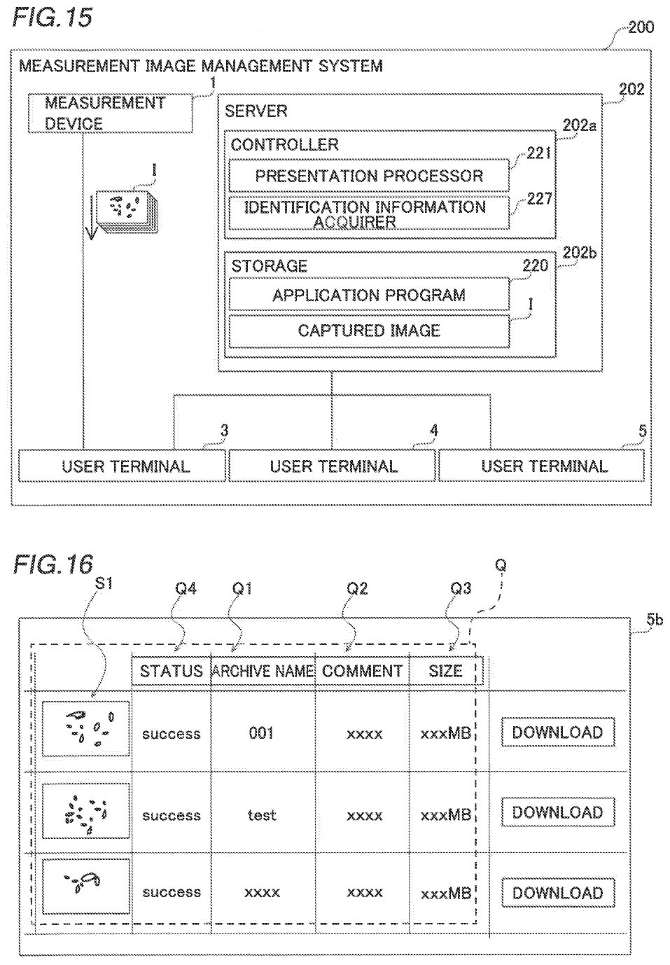

The configuration of a measurement image management system 200 according to a second embodiment of the present invention is now described with reference to FIGS. 15 and 16. In the second embodiment, identification information Q including a representative image S1 that is one of a plurality of selected images S is acquired. In the figures, the same or similar configurations as those of the first embodiment are denoted by the same reference numerals, and description thereof is omitted.

The measurement image management system 200 according to the second embodiment includes a server 202, as shown in FIG. 15. The server 202 is a computer built for a server, similarly to the server 2 according to the first embodiment. The server 202 includes a controller 202a and a storage 202b. The hardware configurations of the controller 202a and the storage 202b are the same or similar as those of the controller 2a and the storage 2b according to the first embodiment. The storage 202b stores application programs 220 to manage captured images I.

The server 202 includes an identification information acquirer 227 and a presentation processor 221 as functional configurations. Specifically, the controller 202a of the server 202 functions as the identification information acquirer 227 and the presentation processor 221 by executing the application programs 220 stored in the storage 202b. The remaining configurations of the server 202 are similar to those of the server 2 according to the first embodiment. That is, the server 202 stores a plurality of captured images I. The server 202 receives a selection on the plurality of stored captured images I and stores the identification information Q to identify the selected images S.

As shown in FIG. 16, in the second embodiment, the identification information acquirer 227 acquires the identification information Q including the representative image S1 that is one of the plurality of selected images S. In the second embodiment, the presentation processor 221 displays the acquired representative image S1 on a plurality of user terminals 3 to 5.

Specifically, the identification information acquirer 227 selects one representative image S1 from among the selected images S. The representative image S1 may be selected based on an input to any one of the user terminals 3 to 5 or may be automatically selected. A storage processor 23 stores the identification information Q including the representative image S1. The presentation processor 221 displays a plurality of pieces of identification information Q including representative images S1 stored in the server 2 on the plurality of user terminals 3 to 5 such that the plurality of pieces of identification information Q are selectable. That is, the presentation processor 221 displays a list of the respective representative images S1 of the plurality of pieces of identification information Q side by side on displays 3b to 5b of the user terminals 3 to 5. Note that FIG. 16 shows an example of displaying on the display 5b of the user terminal 5.

The remaining configurations of the second embodiment are similar to those of the first embodiment.

### Advantages of Second Embodiment

According to the second embodiment, the following advantages are obtained.

According to the second embodiment, as described above, the server 202 includes an image selection receiver 25 configured to receive an image selection to select the plurality of selected images S from among the plurality of captured images I (measurement images) stored in the server 202 based on an input operation for image selection, the identification information acquirer 227 is configured to acquire the identification information Q including the representative image S1 that is one of the plurality of selected images S, and the presentation processor 221 is configured to display the acquired representative image S1 on the plurality of user terminals 3 to 5. Accordingly, the representative image S1 that is one of the plurality of selected images S selected by a first user can be displayed on the user terminal 5 of a second user, and thus the second user can select the identification information Q while referring to the displayed representative image S1. Therefore, when the identification information Q is selected and the plurality of selected images S are transmitted from the server 202 to the user terminal 5 of the second user, the identification information Q corresponding to the necessary selected images S can be more easily selected. Thus, the time and effort required for the selection work to select the necessary selected images S can be further reduced. The remaining advances of the second embodiment are similar to those of the first embodiment.

### Third Embodiment

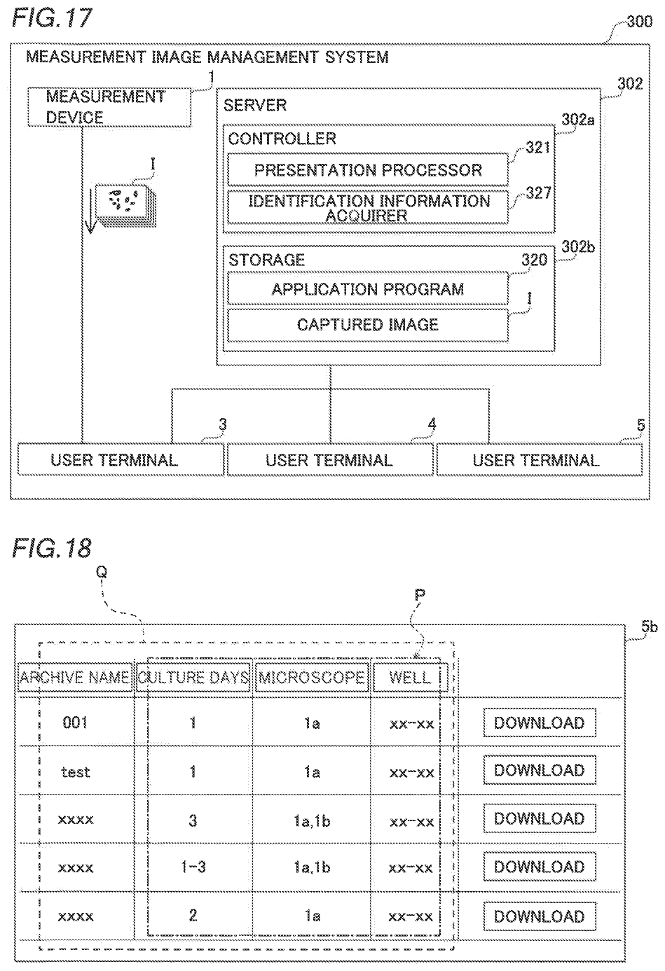

The configuration of a measurement image management system 300 according to a third embodiment of the present invention is now described with reference to FIGS. 17 and 18. In the third embodiment, identification information Q including characteristics information P indicating at least one of a culture period of time, a measurement device 1, or a well corresponding to a selected image S is acquired based on the selected image S. In the figures, the same or similar configurations as those of the first embodiment are denoted by the same reference numerals, and description thereof is omitted.

The measurement image management system 300 according to the third embodiment includes a server 302, as shown in FIG. 17. The server 302 is a computer built for a server, similarly to the server 2 according to the first embodiment. The server 302 includes a controller 302a and a storage 302b. The hardware configurations of the controller 302a and the storage 302b are the same or similar as those of the controller 2a and the storage 2b according to the first embodiment. The storage 302b stores application programs 320 to manage captured images I.

The server 302 includes an identification information acquirer 327 and a presentation processor 321 as functional configurations. Specifically, the controller 302a of the server 302 functions as the identification information acquirer 327 and the presentation processor 321 by executing the application programs 320 stored in the storage 302b. The remaining configurations of the server 302 are similar to those of the server 2 according to the first embodiment. That is, the server 302 stores a plurality of captured images I. The server 302 receives a selection on the plurality of stored captured images I and stores the identification information Q to identify selected images S.

As shown in FIG. 18, in the third embodiment, the identification information acquirer 327 acquires the identification information Q including the characteristics information P indicating at least one of the culture period of time, the measurement device 1, or the well corresponding to the selected image S based on the selected image S. In the third embodiment, the presentation processor 321 displays the characteristics information P indicating at least one of the culture period of time, the measurement device 1, or the well on a plurality of user terminals 3 to 5.

Specifically, the identification information acquirer 327 acquires the characteristics information P indicating the cell culture period of time (culture days), the measurement device 1 (identification number information of microscopes 1a and 1b), and the well (well number) that is recess in which a cell is cultured, which correspond to the selected image S, as the identification information Q. The storage processor 23 stores the identification information Q including the characteristics information P. The presentation processor 321 displays a list of a plurality of pieces of identification information Q including the characteristics information P stored in the server 302 side by side on displays 3b to 5b of the plurality of user terminals 3 to 5 such that the plurality of pieces of identification information Q are selectable. Note that FIG. 18 shows an example of displaying on the display 5b of the user terminal 5. When there are a plurality of types of characteristics information P corresponding to the selected images S, the presentation processor 321 displays the plurality of types of characteristics information P on the displays 3b to 5b such that the plurality of types of characteristics information P are identifiable.

The remaining configurations of the third embodiment are similar to those of the first embodiment.

### Advantages of Third Embodiment

According to the third embodiment, the following advantages are obtained.

According to the third embodiment, as described above, the identification information acquirer 327 is configured to acquire the identification information Q including the characteristics information P indicating at least one of the culture period of time, the measurement device 1, or the well corresponding to the selected image S based on the selected image S, and the presentation processor 321 is configured to display the characteristics information P indicating at least one of the culture period of time, the measurement device 1, or the well on the plurality of user terminals 3 to 5. Accordingly, the characteristics information P indicating at least one of the culture period of time, the measurement device 1, or the well corresponding to the selected image S selected by a first user can be displayed on the user terminal 5 of a second user, and thus the second user can select the identification information Q while referring to the displayed characteristics information P. Therefore, when the identification information Q is selected and the selected images S are transmitted from the server 302 to the user terminal 5 of the second user, the identification information Q corresponding to the necessary selected images S can be more easily selected. Thus, the time and effort required for the selection work to select the necessary selected images S can be further reduced. The remaining advances of the third embodiment are similar to those of the first and second embodiments.

### Modified Examples

The embodiments disclosed this time must be considered as illustrative in all points and not restrictive. The scope of the present invention is not shown by the above description of the embodiments but by the scope of claims for patent, and all modifications (modified examples) within the meaning and scope equivalent to the scope of claims for patent are further included.

For example, while the server 2 (202, 302) stores the plurality of pieces of identification information Q by the storage processor 23, and the presentation processor 21 (221, 321) displays a list of the plurality of pieces of identification information Q stored in the server 2 (202, 302) side by side on the plurality of user terminals 3 to 5 such that the plurality of pieces of identification information Q are selectable in each of the aforementioned first to third embodiments, the present invention is not limited to this. In the present invention, one piece of identification information Q may alternatively be displayed instead of the plurality of pieces of identification information Q.

While the compressed image A, which is the plurality of compressed selected images S, and the identification information Q are stored in association with each other in each of the aforementioned first to third embodiments, the present invention is not limited to this. For example, the selected images S may not be compressed, or the compressed image A may not be generated. That is, the selected images S may be transmitted without being compressed based on the selected identification information Q.

While the progress degree R of each of the plurality of compression processes is displayed on the plurality of user terminals 3 to 5 in each of the aforementioned first to third embodiments, the present invention is not limited to this. For example, the progress degree R may alternatively be displayed on only a user terminal that has received an execution instruction for the compression process, instead of the plurality of user terminals 3 to 5. Alternatively, the progress degree R may not be displayed.

While the compression process is performed by the asynchronous process in which a plurality of processes are performed in parallel in each of the aforementioned first to third embodiments, the present invention is not limited to this. For example, the compression process may alternatively be performed by a synchronous process.

While the compression process is performed on the plurality of selected images S including the created data tree Ia in each of the aforementioned first to third embodiments, the present invention is not limited to this. For example, the compressed image A may not include the data tree Ia. That is, the selected images S included in the compressed image A may not be divided into folders based on the characteristics information P. In that case, data indicating the characteristics information P corresponding to the selected images S is included in the compressed image A such that when the compressed image A is stored in the server 2 (server 12), the compressed image A may be stored in association with the characteristics information P corresponding to the selected images S (captured images I) included in the compressed image A.

While the server 2 (202, 302) stores the plurality of captured images I acquired by imaging the cells with the microscopes 1a and 1b to observe the cell culture in each of the aforementioned first to third embodiments, the present invention is not limited to this. For example, the server may alternatively store measurement images generated based on measurement results from an analyzer such as a mass spectrometer instead of the captured images of the cells.

While the transmission processor 28 transmits, to the user terminal 3, 4, or 5 that has received the input operation for image transmission, the selected images S (compressed image A) and the characteristics information P in association with each other to enable storage of the selected images S and the characteristics information P in the server 12 separate from the server 2 in each of the aforementioned first to third embodiments, the present invention is not limited to this. For example, the selected images S (captured images I) and the characteristics information P may alternatively be directly transmitted in association with each other from the server 2 to the separate server 12.

While the identification information Q including the name information Q1, the comment information Q2, and the capacities Q3 of the selected images S is acquired in the aforementioned first embodiment, the identification information Q including the representative image S1 is acquired in the aforementioned second embodiment, and the identification information Q including the characteristics information P is acquired in the aforementioned third embodiment, the present invention is not limited to this. For example, information indicating image file names of the selected images S may alternatively be acquired as the identification information Q. Furthermore, information indicating the number of selected images S may alternatively be acquired as the identification information Q.

While the presentation processor 21 displays the transmission history information of the selected images S on the plurality of user terminals 3 to 5 in each of the aforementioned first to third embodiments, the present invention is not limited to this. For example, the transmission history information may alternatively be displayed only on a user terminal that has received an input operation for image selection of the selected images S.

While the storage processor 23 deletes the stored identification information Q when the predetermined period of time elapses from the time at which the identification information Q is stored, or when the number of pieces of stored identification information Q exceeds the predetermined number in each of the aforementioned first to third embodiments, the present invention is not limited to this. For example, instead of automatically deleting the identification information Q, a display prompting deletion of the identification information Q may alternatively be provided.

While the measurement image management system 100 (200, 300) includes the three user terminals 3 to 5 in each of the aforementioned first to third embodiments, the present invention is not limited to this. The measurement image management system may alternatively include four or more user terminals, for example.

While the user terminal 3 that transmits (uploads) the captured images I (measurement images) to the server 2 (202, 302) is different from the user terminals 4 and 5 that acquire (download) the selected images S (compressed image A) stored in the server 2 (202, 302) in each of the aforementioned first to third embodiments, the present invention is not limited to this. For example, the user terminal that uploads the captured images I and the user terminals that download the stored selected images S may alternatively be the same. Furthermore, the user terminal that has received the input operation for image selection to select the selected images S and the user terminal that has received the input operation for image transmission may alternatively be the same.

### Aspects

It will be appreciated by those skilled in the art that the exemplary embodiments described above are specific examples of the following aspects.

### (Item 1)

A measurement image management system comprising:

a server configured to store a plurality of measurement images acquired by a measurement device; and

a plurality of user terminals configured to communicate with the server; wherein

the server includes:
an identification information acquirer configured to acquire identification information to identify, from the plurality of measurement images, a selected image selected based on an input operation for image selection on any one of the plurality of user terminals when the selected image selected from among the plurality of stored measurement images is transmitted to any one of the plurality of user terminals;
a storage processor configured to store the identification information acquired by the identification information acquirer;
a presentation processor configured to present the identification information stored by the storage processor to the plurality of user terminals such that the identification information is selectable; and
a transmission processor configured to transmit, to a user terminal that has received an input operation for image transmission among the plurality of user terminals, the selected image corresponding to the selected identification information based on the input operation for the image transmission on any one of the plurality of user terminals to which the identification information has been presented, the input operation for the image transmission being performed separately from the input operation for the image selection.

### (Item 2)

The measurement image management system according to item 1, wherein

the server is configured to store a plurality of pieces of the identification information by the storage processor;

the presentation processor is configured to display a list of the plurality of pieces of identification information stored in the server side by side on the plurality of user terminals such that the plurality of pieces of identification information are selectable; and

the transmission processor is configured to transmit, to the user terminal that has received the input operation for the image transmission, the selected image corresponding to one selected from among the plurality of pieces of identification information listed side by side on the plurality of user terminals based on the input operation for the image transmission.

### (Item 3)

The measurement image management system according to item 1 or 2, wherein

the server further includes:
an image selection receiver configured to receive the image selection to select a plurality of the selected images from among the plurality of measurement images based on the input operation for the image selection on any one of the plurality of user terminals; and
a compression processor configured to generate a compressed image, which is the plurality of selected images compressed by performing a compression process on the plurality of selected images; and

the storage processor is configured to store the identification information and the compressed image corresponding to the identification information in association with each other.

### (Item 4)

The measurement image management system according to item 3, wherein

the compression processor is configured to perform the compression process for each input operation for the image selection on the plurality of user terminals based on the input operation for the image selection on each of the plurality of user terminals; and

the presentation processor is configured to display a progress degree of each of a plurality of the compression processes performed by the compression processor on the plurality of user terminals.

### (Item 5)

The measurement image management system according to item 3 or 4, wherein

the compression processor is configured to perform the compression process on the plurality of selected images by an asynchronous process in which a plurality of processes are performed in parallel; and

the image selection receiver is configured to receive the image selection to select a new selected image while the compression process is being performed by the compression processor.

### (Item 6)

The measurement image management system according to any one of items 3 to 5, wherein

the server further includes a data tree creation unit configured to create a data tree by grouping the plurality of selected images such that the selected images having common characteristics are in a same group; and

the compression processor is configured to perform the compression process on the plurality of selected images including the data tree created by the data tree creation unit.

### (Item 7)

The measurement image management system according to any one of items 1 to 6, wherein

the server is configured to store the plurality of measurement images including a plurality of captured images acquired by imaging a cell with a microscope to observe culturing of the cell in association with characteristics information indicating at least one of a culture period of time of the cell, the measurement device, or a well, which is a recess in which the cell is cultured; and

the storage processor is configured to store the identification information to identify, from the plurality of captured images, the selected image selected from among the plurality of captured images.

### (Item 8)

The measurement image management system according to item 7, wherein

the identification information acquirer is configured to acquire the identification information including the characteristics information indicating at least one of the culture period of time, the measurement device, or the well corresponding to the selected image based on the selected image; and

the presentation processor is configured to display the characteristics information indicating at least one of the culture period of time, the measurement device, or the well on the plurality of user terminals.

### (Item 9)

The measurement image management system according to item 7 or 8, wherein the transmission processor is configured to transmit, to the user terminal that has received the input operation for the image transmission, the selected image and the characteristics information in association with each other to enable storage of the selected image and the characteristics information in a server separate from the server configured to store the plurality of measurement images in association with the characteristics information.

### (Item 10)

The measurement image management system according to any one of items 1 to 9, wherein

the identification information acquirer is configured to acquire the identification information including at least one of name information indicating the selected image or comment information on the selected image; and

the presentation processor is configured to display at least one of the name information or the comment information on the plurality of user terminals.

### (Item 11)

The measurement image management system according to any one of items 1 to 10, wherein

the identification information acquirer is configured to acquire the identification information including at least one of a capacity of the selected image, a number of the selected images, or an image file name of the selected image based on the selected image; and

the presentation processor is configured to display at least one of the capacity of the selected image, the number of selected images, or the image file name on the plurality of user terminals.

### (Item 12)

The measurement image management system according to any one of items 1 to 11, wherein

the server further includes an image selection receiver configured to receive the image selection to select a plurality of the selected images from among the plurality of measurement images stored in the server based on the input operation for the image selection;

the identification information acquirer is configured to acquire the identification information including a representative image that is one of the plurality of selected images; and

the presentation processor is configured to display the acquired representative image on the plurality of user terminals.

### (Item 13)

The measurement image management system according to any one of items 1 to 12, wherein the presentation processor is configured to display, on the plurality of user terminals, transmission history information of the selected image to each of the plurality of user terminals.

### (Item 14)

The measurement image management system according to any one of items 1 to 13, wherein the storage processor is configured to delete the stored identification information when a predetermined period of time elapses from a time at which the identification information is stored, or when a number of pieces of the stored identification information exceeds a predetermined number.

### (Item 15)

A measurement image management server configured to communicate with a plurality of user terminals and store a plurality of measurement images acquired by a measurement device, the measurement image management server comprising:

an identification information acquirer configured to acquire identification information to identify, from the plurality of measurement images, a selected image selected based on an input operation for image selection on any one of the plurality of user terminals when the selected image selected from among the plurality of stored measurement images is transmitted to any one of the plurality of user terminals;

a storage processor configured to store the identification information acquired by the identification information acquirer;

a presentation processor configured to present the identification information stored by the storage processor to the plurality of user terminals such that the identification information is selectable; and

a transmission processor configured to transmit, to a user terminal that has received an input operation for image transmission among the plurality of user terminals, the selected image corresponding to the selected identification information based on the input operation for the image transmission on any one of the plurality of user terminals to which the identification information has been presented, the input operation for the image transmission being performed separately from the input operation for the image selection.

### (Item 16)

A measurement image management method comprising:

storing a plurality of measurement images acquired by a measurement device;

acquiring identification information to identify, from the plurality of measurement images, a selected image selected based on an input operation for image selection on any one of a plurality of user terminals when the selected image selected from among the plurality of stored measurement images is transmitted to any one of the plurality of user terminals;

storing the acquired identification information;

presenting the stored identification information to the plurality of user terminals such that the identification information is selectable; and

transmitting, to a user terminal that has received an input operation for image transmission among the plurality of user terminals, the selected image corresponding to the selected identification information based on the input operation for the image transmission on any one of the plurality of user terminals to which the identification information has been presented, the input operation for the image transmission being performed separately from the input operation for the image selection.

What is claimed is:

1. A measurement image management system comprising:
a server configured to store a plurality of measurement images acquired by a measurement device; and
a plurality of user terminals configured to communicate with the server; wherein
the server includes:
an identification information acquirer configured to acquire identification information to identify, from the plurality of measurement images, a selected image selected based on an input operation for image selection on any one of the plurality of user terminals when the selected image selected from among the plurality of stored measurement images is transmitted to any one of the plurality of user terminals;
a storage processor configured to store the identification information acquired by the identification information acquirer;
a presentation processor configured to present the identification information stored by the storage processor to the plurality of user terminals such that the identification information is selectable; and
a transmission processor configured to transmit, to a user terminal that has received an input operation for image transmission among the plurality of user terminals, the selected image corresponding to the selected identification information based on the input operation for the image transmission on any one of the plurality of user terminals to which the identification information has been presented, the input operation for the image transmission being performed separately from the input operation for the image selection.

2. The measurement image management system according to claim 1, wherein
the server is configured to store a plurality of pieces of the identification information by the storage processor;
the presentation processor is configured to display a list of the plurality of pieces of identification information stored in the server side by side on the plurality of user terminals such that the plurality of pieces of identification information are selectable; and
the transmission processor is configured to transmit, to the user terminal that has received the input operation for the image transmission, the selected image corresponding to one selected from among the plurality of pieces of identification information listed side by side on the plurality of user terminals based on the input operation for the image transmission.

3. The measurement image management system according to claim 1, wherein
the server further includes:
an image selection receiver configured to receive the image selection to select a plurality of the selected images from among the plurality of measurement images based on the input operation for the image selection on any one of the plurality of user terminals; and
a compression processor configured to generate a compressed image, which is the plurality of selected images compressed by performing a compression process on the plurality of selected images; and
the storage processor is configured to store the identification information and the compressed image corresponding to the identification information in association with each other.

4. The measurement image management system according to claim 3, wherein
the compression processor is configured to perform the compression process for each input operation for the image selection on the plurality of user terminals based on the input operation for the image selection on each of the plurality of user terminals; and
the presentation processor is configured to display a progress degree of each of a plurality of the compression processes performed by the compression processor on the plurality of user terminals.

5. The measurement image management system according to claim 3, wherein
the compression processor is configured to perform the compression process on the plurality of selected images by an asynchronous process in which a plurality of processes are performed in parallel; and
the image selection receiver is configured to receive the image selection to select a new selected image while the compression process is being performed by the compression processor.

6. The measurement image management system according to claim 3, wherein
the server further includes a data tree creation unit configured to create a data tree by grouping the plurality of selected images such that the selected images having common characteristics are in a same group; and
the compression processor is configured to perform the compression process on the plurality of selected images including the data tree created by the data tree creation unit.

7. The measurement image management system according to claim 1, wherein
the server is configured to store the plurality of measurement images including a plurality of captured images acquired by imaging a cell with a microscope to observe culturing of the cell in association with characteristics information indicating at least one of a culture period of time of the cell, the measurement device, or a well, which is a recess in which the cell is cultured; and
the storage processor is configured to store the identification information to identify, from the plurality of captured images, the selected image selected from among the plurality of captured images.

8. The measurement image management system according to claim 7, wherein
the identification information acquirer is configured to acquire the identification information including the characteristics information indicating at least one of the culture period of time, the measurement device, or the well corresponding to the selected image based on the selected image; and
the presentation processor is configured to display the characteristics information indicating at least one of the culture period of time, the measurement device, or the well on the plurality of user terminals.

9. The measurement image management system according to claim 7, wherein the transmission processor is configured to transmit, to the user terminal that has received the input operation for the image transmission, the selected image and the characteristics information in association with each other to enable storage of the selected image and the characteristics information in a server separate from the server configured to store the plurality of measurement images in association with the characteristics information.

10. The measurement image management system according to claim 1, wherein
the identification information acquirer is configured to acquire the identification information including at least one of name information indicating the selected image or comment information on the selected image; and
the presentation processor is configured to display at least one of the name information or the comment information on the plurality of user terminals.

11. The measurement image management system according to claim 1, wherein
the identification information acquirer is configured to acquire the identification information including at least one of a capacity of the selected image, a number of the selected images, or an image file name of the selected image based on the selected image; and
the presentation processor is configured to display at least one of the capacity of the selected image, the number of selected images, or the image file name on the plurality of user terminals.

12. The measurement image management system according to claim 1, wherein
the server further includes an image selection receiver configured to receive the image selection to select a plurality of the selected images from among the plurality of measurement images stored in the server based on the input operation for the image selection;
the identification information acquirer is configured to acquire the identification information including a representative image that is one of the plurality of selected images; and
the presentation processor is configured to display the acquired representative image on the plurality of user terminals.

13. The measurement image management system according to claim 1, wherein the presentation processor is configured to display, on the plurality of user terminals, transmission history information of the selected image to each of the plurality of user terminals.

14. The measurement image management system according to claim 1, wherein the storage processor is configured to delete the stored identification information when a predetermined period of time elapses from a time at which the identification information is stored, or when a number of pieces of the stored identification information exceeds a predetermined number.

15. A measurement image management server configured to communicate with a plurality of user terminals and store a plurality of measurement images acquired by a measurement device, the measurement image management server comprising:
an identification information acquirer configured to acquire identification information to identify, from the plurality of measurement images, a selected image selected based on an input operation for image selection on any one of the plurality of user terminals when the selected image selected from among the plurality of stored measurement images is transmitted to any one of the plurality of user terminals;
a storage processor configured to store the identification information acquired by the identification information acquirer;
a presentation processor configured to present the identification information stored by the storage processor to the plurality of user terminals such that the identification information is selectable; and
a transmission processor configured to transmit, to a user terminal that has received an input operation for image transmission among the plurality of user terminals, the selected image corresponding to the selected identification information based on the input operation for the image transmission on any one of the plurality of user terminals to which the identification information has been presented, the input operation for the image transmission being performed separately from the input operation for the image selection.

16. A measurement image management method comprising:
storing a plurality of measurement images acquired by a measurement device;
acquiring identification information to identify, from the plurality of measurement images, a selected image selected based on an input operation for image selection on any one of a plurality of user terminals when the selected image selected from among the plurality of stored measurement images is transmitted to any one of the plurality of user terminals;
storing the acquired identification information;
presenting the stored identification information to the plurality of user terminals such that the identification information is selectable; and
transmitting, to a user terminal that has received an input operation for image transmission among the plurality of user terminals, the selected image corresponding to the selected identification information based on the input operation for the image transmission on any one of the plurality of user terminals to which the identification information has been presented, the input operation for the image transmission being performed separately from the input operation for the image selection.
